(19) United States
(12) Patent Application Publication
(10) Pub. No.: US 2025/0376414 A1
(43) Pub. Date: Dec. 11, 2025

(54) TRANSPARENT GLASS ARTICLE FOR COLD COMPARTMENT AND MULTIPLE GLAZING INCORPORATING SAID ARTICLE

(71) Applicant: SAINT-GOBAIN GLASS FRANCE, COURBEVOIE (FR)

(72) Inventors: Jean-Thomas FONNE, AUBERVILLIERS (FR); Maëlis BANCI, AUBERVILLIERS (FR); Alexandre DEHAUPAS, AUBERVILLIERS (FR); Yael BRONSTEIN, COURBEVOIE (FR)

(21) Appl. No.: 18/877,016

(22) PCT Filed: Jun. 16, 2023
(86) PCT No.: PCT/FR2023/050884

§ 371 Date: Dec. 19, 2024

(30) Foreign Application Priority Data
Jun. 23, 2022 (FR) 2206244
Jun. 24, 2022 (FR) FR2206291

(51) Int. Cl. C03C 17/36; B32B 17/06

(52) U.S. Cl. CPC C03C 17/3673; B32B 17/06; C03C 17/3626; C03C 17/3644; C03C 17/366; C03C 17/3681; B32B 2255/20; C03C 2217/212; C03C 2217/22; C03C 2217/231; C03C 2217/256; C03C 2217/281; C03C 2217/948; C03C 2218/156

(57) ABSTRACT

A glass article includes a glass substrate whereupon a heatable coating is deposited, the heatable coating includes, from the surface of the substrate, a first layer of dielectric material including silicon nitride, with a thickness of between 1 and 20 nm, a layer of a transparent conducting oxide (TCO), with a thickness of between 1 nm and 40 nm, a second layer of dielectric material including silicon nitride, with a thickness of between 1 and 20 nm, a layer including titanium oxide, zirconium oxide or titanium zirconium oxide, with a thickness of between 1 nm and 15 nm.

The invention relates to a glass article comprising a glass substrate whereupon a heating coating is deposited and intended to form part of a multiple glazing used in particular as anti-condensation glazing, in particular in a transparent refrigerator or freezer door, as well as the production thereof.

Heated (or heatable) glass panes, windows and doors with substantially transparent coatings are known per se. Often, the heating coating contains an electrically conductive layer, such as silver layers or a pyrolytic layer of fluorine-doped tin oxide, on which Joule heating is based (functional layer), as well as other dielectric layers that act as anti-reflective layers to maintain good light transmission, or barrier layers to protect the functional layer from external aggressions, such as diffusion of alkaline ions from the glass substrate, or oxidation by oxygen in the air during heat treatment. The disadvantage of coatings containing silver is their high susceptibility to corrosion, which means that they can only be used on surfaces of a multiple glazing (multiple or laminated glazing) that have no contact with the surrounding atmosphere, for example face 2 or 3 of a multiple glazing, the faces being conventionally numbered from the outside toward the inside of the equipment fitted with said multiple glazing.

Heating coatings based on transparent conductive oxides (TCO) are also known as a less corrosion-sensitive alternative. These can even be used on the exposed surfaces of atmospheric glass. Because of the lower conductivity of TCO compared with silver, it was long thought that TCO layers, especially ITO (for Indium Tin Oxide), had to be relatively thick to achieve adequate thermal efficiency. As a result, production costs for glass panes are considerably higher. TCO-based heating coatings are known, for example, from WO2012168628A1, WO2007018951A1, U.S. Pat. No. 5,852,284A, and US2004214010A1.

For example, WO2015091016 discloses a vehicle window having an electrically heatable coating. The coating preferably contains silver layers, but transparent conductive oxides are also mentioned as an alternative. The glass pane is preferably a windscreen, that is, a composite glass pane, wherein the heating coating is arranged on an inner surface, where it is protected from the surrounding atmosphere.

Publication WO2007018951A1 discloses a glass pane with a TCO coating. Above the TCO layer is a silicon nitride barrier layer, designed to protect the TCO layer from oxidation during a tempering process. The appropriate or necessary thickness of the barrier layer is not disclosed.

Patent application WO2018/192727 discloses a heatable coating with a much thinner TCO functional layer of about 1 to 40 nm. With this publication, the applicant company has demonstrated that a very thin conductive layer of TCO, in particular ITO (Indium Tin Oxide), provides a sufficient heating effect despite its very low thickness, even when using the usual supply voltages. This considerably reduces production costs. Owing to such a heating effect of its coating, the glass equipped with the disclosed coating can sufficiently heat its physical environment and can be freed from condensation or frost, creating a particularly beneficial effect in refrigerating applications.

However, during the manufacture of multiple glazings incorporating such a coating on face 2 of said glazing, the applicant company has observed that, due to the very low thickness of the functional layer, problems of homogeneity in the heating of the latter have resulted in increased variability in the total strength of the coating after tempering, with some samples even falling outside the required specification.

The object of the present document is firstly to solve the problem of inhomogeneous heating of these glazings, which feature a very thin TCO heating layer, that is, of the order of 1 nanometer to 40 nanometers.

The object of the present invention is achieved by implementing a glass article for a cold compartment comprising a glass substrate whereupon a heatable coating is deposited, said heatable coating comprising at least the following succession of layers, from the surface of said substrate:
a first layer of dielectric material comprising silicon nitride, having a thickness of between 1 and 20 nm, preferably between 1 and 10 nm,
a layer of transparent conducting oxide (TCO), having a thickness of between 1 and 40 nm, preferably between 5 and 35 nm,
a second layer of dielectric material comprising silicon nitride, having a thickness of between 1 and 20 nm, preferably between 1 and 15 nm, preferably between 5 and 15 nm,
a layer comprising a titanium oxide, a zirconium oxide or a titanium zirconium oxide, with a thickness of between 1 nm and 15 nm, preferably between 1 and 10 nm, or even more preferably between 1 and 5 nm.

According to certain preferential embodiments of the present invention:
The electrically conductive layer comprises and is preferably based on indium tin oxide.
The electrically conductive layer is from 8 nm to 15 nm thick.
The electrically conductive layer is from 15 nm to 30 nm thick.
Said first dielectric layer consists essentially of silicon nitride, optionally doped with an element selected from Al, Zr, B, preferably Al, said layer optionally being partially oxidized by a heat treatment.
Said second dielectric layer consists essentially of silicon nitride, optionally doped with an element selected from Al, Zr, B, preferably Al, said layer optionally being partially oxidized by a heat treatment.
The glass article further comprises at least two busbars arranged above and in contact with said heatable coating.
Said at least two busbars are arranged along two opposite ends of said article, preferably in the direction of its greatest length.
Said coating has a sheet resistance of between 50 ohms per square and 400 ohms per square.
The substrate is a thermally prestressed glass pane, either before or after the coating has been applied.
Said heatable coating does not contain a layer comprising or based on silver, platinum or gold.
Said heatable coating does not contain a layer comprising or based on nickel and/or chromium and/or copper.
Said first and second layers of dielectric material comprising silicon nitride are in direct contact with the layer of an electrically conductive transparent oxide (that is, there is no intermediate layer between the TCO layer and said layers of dielectric material comprising silicon nitride).
The layer comprising titanium oxide, zirconium oxide or titanium zirconium oxide is in direct contact with the second layer of dielectric material comprising silicon nitride.

The invention also relates to a multiple glazing, comprising a glass article according to one of the preceding claims and at least one other glass substrate separated from said article by a layer of gas or a thermoplastic sheet, in particular of PVB, said coating being in contact with the layer of gas or the thermoplastic sheet.

According to possible and preferred embodiments of such a multiple glazing:
Said coating is deposited on face 2 or face 3 of said glazing, preferably said coating is deposited on face 2 of said glazing.
The glazing further comprises a low-emissivity stack, preferably deposited on face 3 of said glazing.
The glazing is a double glazing, preferably wherein said coating is deposited on face 2 of said glazing and more preferably a low-emissivity stack is deposited on face 3 of said glazing.
The glazing is a triple glazing, wherein said coating is deposited on face 2 or face 5 of said glazing, preferably on face 2 of said glazing.
Said coating is deposited on face 2 of said triple glazing and said glazing comprises a low-emissivity coating, said low-emissivity coating being arranged on face 3 and/or on face 5, preferably on face 3 or face 5 of said glazing.
Said coating is deposited on face 5 of said triple glazing and said glazing comprises a low-emissivity coating, said low-emissivity coating being arranged on face 2 and/or on face 4, preferably on face 2 of said glazing.
Said low-emissivity stack(s) comprise at least one layer of silver and layers of dielectric materials.
Said low-emissivity stack(s) comprise a layer of ITO and layers of dielectric materials.

A glass article according to the present invention and as described previously can advantageously be used in the manufacture of any refrigerating element and in particular as the front element of a refrigerator door or a freezer door. Owing to the heating effect of the coating, the article whose uncoated side is in contact with the outside environment heats up its physical environment and prevents condensation on the outside, creating a particularly beneficial effect in these applications. The coating according to the invention is characterized in particular by its very thin TCO conductive layer, the thickness of which is much thinner than those usually used in the art. The inventors have discovered that a homogeneous heating effect over the entire surface of the glass article can be achieved with the coating disclosed previously, even using the usual supply voltages used in various countries, for example between 40 and 250 volts, particularly between 100 and 240 volts. Production costs are considerably reduced by using fewer materials, especially the TCO layer, preferably ITO.

The invention thus concerns the use of such a glass article for the manufacture of such a cooling element.

The glass article according to the invention preferably has a transmission in the visible spectral range of at least 40%. “Visible spectral range” refers to the spectral range from 380 nm to 780 nm. The transmission factor is preferably determined in accordance with EN 410 (2011).

The coating according to the invention has a sheet resistance of 50 ohms/square to 400 ohms/square, preferably 50 ohms/square to 300 ohms/square. Such a resistance can be achieved with the thin TCO films according to the invention, and allows suitable thermal efficiency to be obtained with the usual operating voltages disclosed previously.

The substrate generally consists of flat glass. In a preferred embodiment, the substrate contains soda-lime glass, but in principle can also contain other types of glass, for example borosilicate glass or quartz glass. The substrate is preferably 1 mm to 20 mm thick, typically 2 mm to 6 mm. The substrate can be flat or even curved In a particularly advantageous embodiment, the substrate is a thermally prestressed glass pane.

According to the invention, the coating is advantageously arranged on an unexposed surface of the substrate, that is, it is present on the face of the substrate that will face the interior of the final glazing, which may be of the multiple glazing (also known as insulating glazing) or laminated type. Thus, the glass article according to the invention forms part, in operation, of an assembly comprising several sheets (or substrates) of glass which comprises at least one other glass substrate in addition to that of the article according to the invention.

“Multiple glazing” means a glazing wherein a succession of glass sheets or substrates are spaced apart by gas plate(s). In such multiple glazings, the article according to the invention is connected to one or more other glass panes by means of a peripheral spacer, often called a spacer in the field, so that an intermediate gap filled with gas such as air or, more rarely, argon or Krypton (or, even more rarely, a vacuum) is created between the glass panes.

Laminated glazing refers to a glazing wherein a succession of glass sheets or substrates are bonded by a thermoplastic interlayer sheet. In laminated glazings, the article according to the invention is laminated with one or more other glass sheets via a thermoplastic interlayer, in particular PVB (polyvinyl butyral).

In particular, one of the objects of the invention is therefore a refrigerating element and in particular a front element of a refrigerator door or a freezer door incorporating the glass article previously disclosed, in particular in the form, for example, of a multiple or laminated glazing, in the sense previously disclosed.

The coating according to the invention as described previously is typically applied to the entire surface of the substrate, possibly with the exception of a circumferential edge region and/or another locally limited region which may be used, for example, for data transmission. The coating can also be structured by uncoated lines through which the flow of current can be suitably directed. The coated portion of the substrate surface is preferably at least 90%.

When a layer “comprises” a material, this includes, in the context of the invention, the case where the layer is essentially made of or even consists of said material, which is, in principle, also preferable. The compounds disclosed within the scope of the present invention, in particular oxides, nitrides, can, in principle, be stoichiometric, sub-stoichiometric or superstoichiometric, although stoichiometric molecular formulas are often cited for better understanding.

In particular, the layers comprising silicon nitride comprise predominantly silicon and nitrogen as main constituents. In particular, silicon and nitrogen together represent more than 50%, more than 60%, indeed even more than 70%, or even more than 80% of the atoms present in a layer, or indeed even more than 90% of the atoms present in a layer. Preferably, said layers comprising silicon nitride consist essentially of silicon and nitrogen and optionally of at least one element selected from aluminum, boron or zirconium, preferably aluminum, with inevitable impurities. Said layers comprising silicon nitride are in principle free of oxygen, with inevitable impurities after deposition; for example, they comprise less than 5 mol % elementary oxygen, in particular less than 1 mol % elementary oxygen. However, layers containing silicon nitride may end up containing a much greater quantity of oxygen, particularly after heat treatment of the glass articles according to the invention in air, such as tempering, which will often lead to partial oxidation of said layers. Preferably, said layers have an N/Si ratio greater than 1.25 and are stoichiometric layers. “Stoichiometric” means that the N/Si ratio is equal to 1.33 for these silicon-based nitride layers, corresponding to the Si₃N₄ compound. “Substantially stoichiometric” means, for example, that the value measured for this Si3N4 compound differs from this theoretical value by less than 5%. Indeed, it should be noted that the layers comprising silicon nitride according to the invention are obtained by a magnetron-assisted cathode sputtering process from a metal silicon target which may comprise a minor amount of another element such as aluminum and/or zirconium, for example about 8 at. % of aluminum, in a reactive atmosphere containing nitrogen. In such a case, the N/Si ratio may vary substantially from the theoretical value 1.33 (=4/3) (corresponding to the defined compound Si3N4) taking into account the stoichiometries of the defined AlN and Si3N4 compounds. By way of example, for a layer of silicon nitride comprising a small amount of aluminum and obtained with the target described above (8% aluminum), the N/Si ratio of the stoichiometric layer theoretically corresponds to a formulation: 92% (SiN1.33)/8% (AlN), or an N/Si ratio of 1.41 (based on a theoretical formula 0.92 SiN1.33 0.08 AlN, or an N/Si ratio=[(0.92×1.33+0.08×1)/(0.92)]=1.41).

The values indicated for the refractive indices are measured at a wavelength of 550 nm.

According to the invention, the electrically conductive layer contains at least one transparent conducting oxide (TCO) and has a thickness from 1 nm to 40 nm, preferably from 5 nm to 35 nm. Even with these low thicknesses, an adequate heating effect can be achieved with an appropriate voltage. The conductive layer very preferentially contains indium tin oxide (ITO), which has proved particularly useful, not least because of its low specific resistance. Additionally, by applying the principles of the invention, a very uniform heating effect can be ensured with such a material.

Conventionally, the composition of ITO layers is about 90% by weight In₂O₃ and 10% by weight SnO₂, it being understood that the present invention is of course not limited to such proportions and that these percentages can of course fluctuate around this composition, for example in a range between 70 and 95% by weight In₂O₃ and between 30 and 5% SnO₂.

However, the conductive layer can also contain, for example, mixed indium zinc oxide (IZO), gallium-doped tin oxide (GZO), fluorine-doped tin oxide (SnO2:F) or antimony-doped tin oxide (SnO2:Sb). The refractive index of the transparent conducting oxide is preferably between 1.7 and 2.3.

According to the invention, the coating comprises, beneath the electrically conductive TCO layer, a first layer of a dielectric material that provides blocking against alkali diffusion, particularly during heat treatment of the article. The blocking layer reduces or prevents the diffusion of alkali ions from the glass substrate into the system of layers. Alkaline ions can have a negative impact on coating properties. In particular, the blocking layer comprises a silicon nitride. As previously mentioned, the silicon nitride can be doped and, in a preferred development, is doped with aluminum, zirconium or boron. The amount of Al, Zr or B substituted for silicon is usually of the order of 8 at. %, but can vary around this value without going beyond the scope of the present invention. The thickness of this first layer of alkali-blocking dielectric material is preferably between 1 nm and 50 nm, particularly preferably between 2 nm and 20 nm, especially between 3 and 10 nm.

It is known that the oxygen content of the electrically conductive layer, in particular ITO, has a substantial influence on its properties, in particular its transparency and conductivity. The production of the glass article according to the invention generally comprises a heat treatment during which oxygen can diffuse to the conductive layer and oxidize it. According to the present application, a barrier layer of a dielectric material, comprising silicon nitride, makes it possible to limit oxygen diffusion and degradation of the electrical properties of the conductive layer. According to the present invention, and like for the first dielectric layer, the silicon nitride can be doped with various elements, and in a preferred development, it is doped with aluminum, zirconium or boron, generally in the proportions previously disclosed.

Within the meaning of the present invention, as previously indicated, in particular as a result of heat treatment after application of the coating according to the invention, the silicon nitride may be partially oxidized. A barrier layer deposited in the form of silicon nitride may therefore contain a non-negligible portion of oxygen after heat treatment, the oxygen content being up to 35 at. %.

The thickness of the barrier layer or second dielectric is preferably from 1 nm to 20 nm. If the barrier layer is thinner, it has little or no barrier effect. If the barrier layer is too thick, it can be problematic to make electrical contact with the underlying conductive layer, for example by means of a busbar applied to the barrier layer. The thickness of the barrier layer is preferably from 2 nm to 15 nm. In this way, the oxygen content of the conductive layer is advantageously regulated.

In a possible but not preferred embodiment, the heatable coating according to the invention may contain layers of dielectric materials other than the two previously disclosed, in particular to modulate the optics of the electrically conductive layer.

These optical adaptation layers are designed to improve the optical properties of the glazing. They can thus be introduced to reduce the degree of reflection and thus increase the transparency of the glazing. They can also be incorporated into the coating to ensure a neutral color impression. The optical matching layer and/or the anti-reflective layer have a lower refractive index than the electrically conductive layer, preferably a refractive index from 1.3 to 1.8. The optical matching layer and/or the anti-reflective layer preferably contains an oxide, preferably silicon oxide. The silicon oxide can be doped, preferably with aluminum, boron or zirconium.

These optical matching layers can be arranged either above or below the conductive layer in the coating, and are preferably arranged in contact with layers comprising silicon nitride, said layers comprising silicon nitride being held in contact with the TCO conductive layer. In other words, the optical matching layers, often made of oxides, are not in contact with the TCO layer.

According to a preferred embodiment according to the invention, however, the coating according to the invention consists of the succession of:
a first layer of dielectric material comprising silicon nitride,
an electrically conductive transparent oxide (TCO),
a second layer of dielectric material comprising silicon nitride,
a layer of a titanium oxide, a zirconium oxide or a titanium zirconium oxide, without the presence of intermediate layer(s), that is, the successive layers are in direct contact with one another and the coating contains no other layers.

The coating according to the invention is thus completed in the outermost layer, that is, the layer furthest from the substrate surface, by a layer comprising a titanium oxide, a zirconium oxide or a titanium zirconium oxide. Said titanium zirconium oxide layer may contain between 1 and 99% by weight of titanium oxide and between 99% and 1% by weight of zirconium oxide. Advantageously, said titanium zirconium oxide layer may contain between 70% and 80% by weight of titanium oxide and between 30% and 20% by weight of zirconium oxide. The thickness of this layer is between 1 and 15 nm and advantageously between 2 and 10 nm. Surprisingly, it was found that the presence of this additional layer guaranteed homogeneous heating at the glazing surface, and in particular limited the variability of the total resistance of the stack after tempering on a sample of a multitude of glazings thus constituted.

A layer comprising titanium oxide, zirconium oxide or titanium zirconium oxide comprises said oxides as main constituents. Said atoms of Ti and/or Zr represent more than 50%, more than 60%, indeed even more than 70%, or even more than 80% of the atoms present in a layer aside from oxygen, or indeed even more than 90% or even more than 95% of the atoms present in a layer aside from oxygen. Preferably, said layers comprising titanium oxide, zirconium oxide or titanium zirconium oxide consist essentially of said oxides.

To operate, the coating is brought into contact with busbars that can be connected to the poles of a voltage source to introduce current into said coating over the entire width of the glass pane or at least a large part of the width of the glass pane, thereby heating it by Joule effect.

The bars are preferably printed and baked conductors containing at least one metal, preferably silver. Electrical conductivity is preferably achieved by means of metal particles contained in said bars, and more particularly by means of silver particles. The metal particles can be located in an organic and/or inorganic matrix such as pastes or inks, preferably in the form of screen printing paste fired with glass frits. The layer thickness of the printed busbars is preferably between 5 μm and 40 μm, particularly preferably between 10 μm and 20 μm. Printed busbars with these thicknesses are technically simple to produce and offer advantageous current-carrying capacity. In another possible embodiment, the busbars are implemented as strips of an electrically conductive sheet, in particular a metal foil, for example copper foil or aluminum foil. The foil strips can be laid, glued or welded. The foil thickness is preferably between 30 μm and 200 μm.

In operation, the glass article included in a glazing according to the invention is connected to a voltage source preferably having a voltage of 40 V to 250 V, for example 110V in the USA and in many South American countries. When the glazing operates with these voltages, good thermal efficiencies are obtained, sufficient to allow the glazing to be rapidly rid of condensation, or to prevent condensation from happening in the first place.

In a first preferred embodiment, the voltage is between 210 V and 250 V, for example between 220 V and 230 V. The glazing according to the invention can then be operated with the standard mains voltage, which is particularly suited to a heat output that enables the glazing to be quickly freed from condensation on the outside.

In a second preferred embodiment, the voltage is of the order of 110 to 120 V, corresponding to the voltage applied to mains outlets in countries such as the USA, Mexico or other Latin American countries.

The invention also comprises a method for producing a glass article having a heatable coating, comprising the following steps:
a) a coating successively comprising at least the following layers is deposited on a surface of a glass substrate by vacuum magnetron deposition:
   a first layer of dielectric material comprising silicon nitride,
   a transparent conducting oxide (TCO), in particular ITO,
   a second layer of dielectric material comprising silicon nitride,
   a layer of a titanium oxide, a zirconium oxide or a titanium zirconium oxide,
b) a busbar is deposited on said coating,
c) heat treatment, such as tempering, is performed to achieve thermal prestressing of the glass substrate.

During step c), the substrate is heated to a temperature of around 650 to 750° C. and then subjected to a stream of air which rapidly cools it. Compressive stresses are generated at the glass surface, and tensile stresses at the glass core. The characteristic stress distribution increases the breaking strength of the glass sheets. Prestressing can also be preceded by a curving process.

According to an alternative embodiment, the busbars are installed after the heat treatment step (inversion of previous steps b) and c).

However, the deposition of the conductive bars is preferably carried out before the heat treatment, so that the curing of the printing paste can be carried out during the heat treatment and does not need to be carried out as a separate step.

The busbars are preferably printed, particularly preferably by screen printing, in the form of a paste containing silver with glass frits, or laid or glued or soldered as strips of a conductive foil.

A multiple glazing can then be obtained according to the invention by sealing with another substrate and by means of a thermoformable spacer, as disclosed previously and in the remainder of this disclosure.

The various layers of the heating coating are deposited by methods known per se, preferably by magnetron-assisted sputtering. This method is particularly advantageous in terms of simple, fast, economical and uniform substrate coating. Sputtering is carried out in a protective gas atmosphere, e.g. argon, or in a reactive gas atmosphere, e.g. by adding oxygen or nitrogen. However, the layers can also be deposited by other methods known to the skilled person, for example by chemical vapor deposition (CVD), atomic layer deposition (ALD), plasma-enhanced chemical vapor deposition (PECVD) or wet chemical methods.

The invention also comprises the use of a glass substrate according to the invention having an operating voltage of 40 V to 250 V, preferably as a component of a refrigerator door. The operating voltage is preferably 110 V to 120 V, or 210 V to 250 V, for example around 220 V or 230 V. The article according to the invention can be used as part of a multiple glazing with an insulating function, wherein it is connected to at least one other glass substrate by a peripheral, preferably circumferential, spacer, so that an intermediate gap that can be filled with gas is formed between the glass panes.

Preferably, this other substrate is itself provided, on its inward-facing face (face 3 of the multiple glazing), with a so-called low-emissivity (or low-e) stack as disclosed below. The advantage of such a stack is that the infrared radiation from the heating coating is directed outwards, and the refrigerated interior space is not heated.

Within the meaning of the present disclosure, a low-emissivity coating means a coating whose normal emissivity, as measured when deposited on clear glass and in accordance with ISO10292 Annex A (1994), is less than 0.2, preferably less than 0.1 or even less than 0.05.

Such stacks are well known and in particular most often (but not exclusively) comprise a combination of precious metal-based layers, in particular silver-based layers, and dielectric materials often referred to as interference layers. As is well known, these stacks are made up of a succession of layers of dielectric materials such as oxides and/or nitrides and metal layers, including silver-based layers whose “low-emissivity” properties enable them to reflect infrared light selectively and to let through most of the visible light in the solar spectrum (wavelengths between 380 and 780 nm), preferably more than 70%, or even more than 80% of visible light, in particular by minimizing light reflection by means of said interference layers or combination(s) of interference layers.

In particular, the low-e stacks according to the invention are selected so that their sheet resistance is less than 3.5 Ohms per square, preferably even less than 2.0 Ohms per square, or even less than 1.5 Ohms per square. Sheet resistance can be measured, for example, using a device such as the SRM-14T from Nagy Mess-systems.

Such stacks can comprise up to several dozen layers of thicknesses ranging from 1 to 30 nm, and are currently deposited using sputtering techniques, often magnetron-assisted. Preferred low-emissivity stacks according to the invention preferably comprise one or two silver-based layers, although it is of course possible to use stacks comprising three or even four silver-based layers.

Examples of low-emissivity stacks comprising one or two silver layers are notably disclosed in publications such as FR2940272A1, EP1993965B1, EP1656328B1, EP718250, EP847965, or WO03/01105.

Examples of low-emissivity stacks comprising three or four silver layers are notably disclosed in publications WO2005/051858A1, WO2013/104439 and WO2013/107983 cited previously.

Without going beyond the scope of the invention, the multiple glazing can be a double glazing (2 glass substrates) or a triple glazing (3 glass substrates).

In the following, the invention is explained in detail with reference to drawings and possible but non-limiting embodiments of the present invention. The drawings are schematic and not to scale. The drawings in no way limit the invention.

FIG. 1 is a cross-sectional view of a glass substrate according to the invention comprising a heating coating,

FIG. 2 is a cross-section of a double glazing according to the present invention.

FIG. 3 is a cross-section of a triple glazing according to the present invention.

FIG. 4 is a top view of a glass article according to the invention equipped with a heating coating according to the invention used in the following examples.

FIGS. 5 to 8 are graphs showing the electrical resistance measurements of the comparative examples and according to the invention, of double glazing and triple glazing according to the configurations disclosed in FIGS. 2 and 3, respectively.

### DESCRIPTION OF THE FIGURES

FIG. 1 shows a cross-section of a glass article according to the invention, comprising a glass substrate 1, a heating coating 2 and busbars 3. The substrate 1 is, for example, a soda-lime glass sheet and has a thickness of 3 to 4 mm. The heatable coating 2 consists of 4 successive layers starting from the substrate surface, including:
a first layer 4 based on silicon nitride, having a thickness of between 1 and 20 nm,
a layer 5 of a transparent conductive oxide (TCO), in particular ITO, with a thickness of between 1 nm and 40 nm,
a second layer 6 based on silicon nitride, having a thickness of between 1 and 20 nm,
a layer 7 comprising a titanium oxide, a zirconium oxide or a titanium zirconium oxide, with a thickness of between 1 nm and 15 nm, preferably between 1 and 10 nm, or even between 1 and 5 nm, which is the last layer of the coating.

Above and in contact with the coating, two busbars 3 are arranged on both sides of the substrate, as shown in FIG. 4. The bars 3 are arranged along two opposite ends of said article, preferably in the direction of its greatest length.

FIG. 4 shows the position of the bars 3, in a top view of the glass article according to the invention.

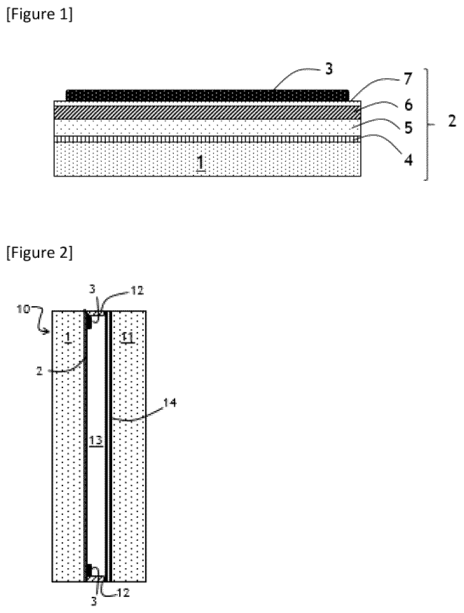

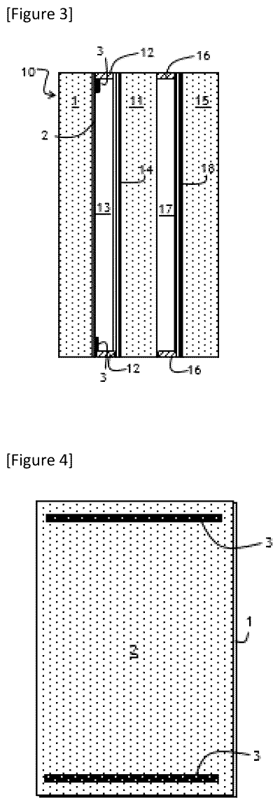

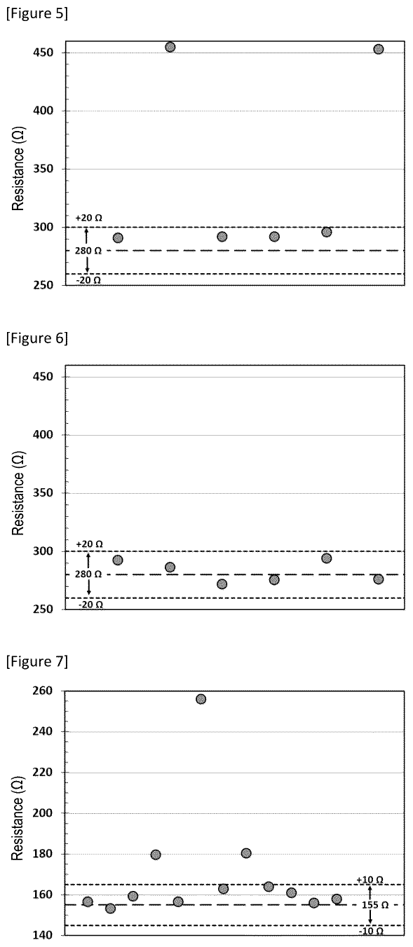

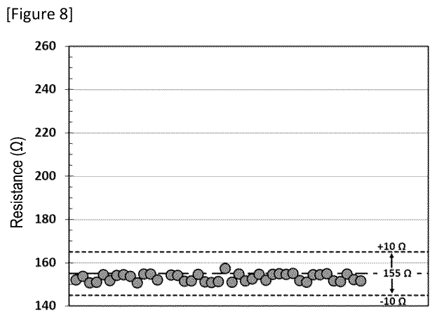

FIG. 2 shows a schematic view of a double glazing 10 comprising the glass article of FIGS. 1 and 4 assembled with a second glass substrate 11 by means of a spacer 12 made of thermoformable material to delimit between the two glass sheets a cavity 13 containing a gas which can conventionally be air but also a rare gas such as argon or krypton for improved insulation. This second glass substrate is provided with a low-emissivity stack 14 of the type disclosed above, preferably comprising at least one silver layer surrounded by dielectric layers. The heatable coating 2 is connected to a device for energizing the busbars 3 (not shown in the figures), comprising connectors welded to the bars 3 and to electrical cables (not shown) which are in turn connected in operation to a voltage generator, in particular a simple mains socket, for the passage of electrical current through the heatable coating 2.

In such a multiple glazing according to the invention, the heatable coating 2 is advantageously arranged on face 2 of the multiple glazing, the faces being conventionally numbered from the outside to the inside of the glazing (in the case of a refrigerating door, the inside being the body of the refrigerating element).

Likewise, the low-emissivity stack is arranged on face 3 of the multiple glazing.

Thus, according to the present invention, the heatable coating 2 and the low-emissivity stack 3 face the inside of the multiple glazing, that is, in contact with the cavity 13 thereof.

When the coating 2 is heated, it raises the temperature of the outer surface of the glass substrate 1, thus preventing condensation on the outer surface of the refrigerator door. Similarly, the combination of the heating coating on face 2 of the glazing and the low-emissivity stack 14 on face 3 of the glazing helps prevent condensation. The presence of a low-emissivity stack means that the outer surface is kept cooler, resulting in lower energy consumption by the cooling element. According to the invention, it becomes possible to significantly reduce the heating power on the ITO layer to above the dew point of the outer surface and thus to avoid condensation.

Finally, the coatings according to the invention have high transmittance and low reflectivity, so that they do not critically reduce vision through the glass. Such a configuration is particularly well suited to the use of such a glazing as a transparent door for a refrigerator, that is, a compartment whose interior space is maintained at temperatures down to around −5° C.

However, it would not depart from the scope of the present invention if the heating coating 2 were arranged on face 3 of the double glazing, in particular to avoid condensation this time on the inner glass of the double glazing. In such a configuration, the low-emissivity coating 14 is advantageously deposited on face 2 to limit the energy consumption of the cooling element.

In the case where the glazing according to the invention is used as the door of a freezing device, that is, where the interior temperature is below −15°, or even below −20° C., the triple glazing configuration shown in FIG. 3 is appropriate, although a double glazing configuration as disclosed above could also be used without departing from the scope of the invention. However, the triple glazing seems to consume less energy and is therefore a more economical solution.

In such a triple glazing, a third sheet of glass 15 is used, which is connected to the other two by means of a second spacer 16 to delimit, between the two sheets of glass, a second cavity 17 comprising a gas which can conventionally be air but can also be a rare gas such as argon or krypton for better insulation. This third glass substrate is provided with another low-emissivity stack 18 of the type disclosed previously, or even identical to it, and preferably comprising at least one silver layer surrounded by dielectric layers, this stack being arranged on face 5 of the triple glazing.

However, it would not depart from the scope of the present invention if the heating coating were arranged on face 5 of the triple glazing, in particular to avoid condensation this time on the inner glass of the triple glazing.

In such a configuration, the low-emissivity coating 18 is advantageously deposited on face 2, or face 4, or face 2 and face 4, to limit the energy consumption of the cooling element.

According to the invention, for the two embodiments disclosed previously (double or triple glazing), based on the temperature inside the cold compartment and the external conditions (in particular the external temperature and the external humidity level), it is possible to program the operation of the heating coating to always be above the dew point at the external glass surface of the glazing (face 1 of the double or triple glazing) and thus to avoid the formation of condensation on the outer surface thereof.

The following examples, which are purely illustrative and non-limiting examples of the present invention, provide a better understanding of its advantages.

### A—Double Glazing Configuration

Initially, two series of glass articles are synthesized using conventional, well-known vacuum magnetron deposition techniques.

According to a first series of reference articles, a stack is deposited by magnetron-assisted cathode sputtering on a clear glass substrate marketed by the applicant company under the reference Planilux with a thickness of 3.15 mm and dimensions L 684 mm×H 822 mm, the stack successively comprising, from the glass surface:
a layer based on silicon nitride with a thickness of 5 nanometers
a transparent ITO conductive layer with a thickness of 10 nanometers
a layer based on silicon nitride with a thickness of 10 nanometers.

In a second series of articles according to the invention, a stack according to the invention is deposited on the same glass substrate, the stack successively comprising from the glass surface:
a layer based on silicon nitride with a thickness of 5 nanometers
a transparent ITO conductive layer with a thickness of 10 nanometers
a layer based on silicon nitride with a thickness of 10 nm
a layer of titanium zirconium oxide with a thickness of 2 nanometers.

Said titanium zirconium oxide layer is obtained by sputtering a ceramic target comprising between 70% and 80% by weight of TiO2 and between 20% and 30% by weight of ZrO2, in an argon/oxygen atmosphere, using conventional magnetron-assisted cathode sputtering techniques, which are perfectly familiar to the skilled person.

In both coating configurations, the sheet resistance measured is about 250 ohms per square.

For all the articles obtained in this way, the glass panes are trimmed, edged and washed, and the busbars are screen-printed manually by depositing an Ag paste in a glass frit (88% silver by weight) marketed by the company Ferro, according to the diagram shown in FIG. 4. The dimensions of the bars 3 are as follows:
bar width: 654 mm
bar spacing: 734 mm

The article is then heated to 715° C. and tempered according to current techniques. Connectors are then welded to each of the strips 3 and electrically connected via electrical cables to a multimeter to measure their total resistance.

The glass articles thus obtained are then assembled in double glazing with another glass substrate comprising a low-emissivity stack incorporating 1 silver layer as described in Example 1 of publication FR2940272A1, according to the principles given previously and in accordance with FIG. 2 attached hereto. The heating coating is arranged on side 2 and the low-emissivity stack is located on side 3 of the double glazing.

For each of the configurations obtained, the total resistance of the coating 2 is measured for both series of glazings (according to the invention and reference).

In view of the dimensions of the busbars, the distance between them and the dimensions of the glazing, a resistance of around 280 ohms is expected, with an allowance of plus or minus 20 ohms.

FIGS. 5 and 6 show the coating resistances obtained for all the glazings measured (one point corresponding to one sample).

FIG. 5 shows the glazings of the first series of reference articles and FIG. 6 shows the glazings of the second series of articles according to the invention.

It can be seen that the glazings according to the invention show less variability in the total strength of the stack after tempering.

Additionally, some samples in the reference series even fall outside the required specification, as can be seen in FIG. 5, whereas all the samples according to the invention comply with said specification (cf. FIG. 6).

Additional real-life tests have shown that the use of such a glazing as a transparent refrigerator door effectively prevents the formation of condensation on the outer surface of the glazing and ensures perfect visibility through it in cold conditions of around −4° C., even when a relatively low voltage is applied to the heatable coating, namely of about 110 V.

### B—Triple Glazing Configuration

According to a second series of experiments, glass articles configured for use in a triple glazing suitable for use as a transparent door are manufactured.

According to a first series of reference articles stack is deposited by magnetron-assisted cathode sputtering on a clear glass substrate marketed by the applicant company under the reference Planilux with a thickness of 3.15 mm and dimensions L 678 mm×H 1543 mm, the stack successively comprising:
a layer based on silicon nitride with a thickness of 5 nanometers
a transparent ITO conductive layer with a thickness of 27 nanometers
a layer based on silicon nitride with a thickness of 10 nanometers.

In a second series of articles according to the invention, a stack according to the invention is deposited on the same glass substrate, the stack successively comprising:
a layer based on silicon nitride with a thickness of 5 nanometers
a transparent ITO conductive layer with a thickness of 27 nanometers
a layer based on silicon nitride with a thickness of 10 nm
a layer of titanium oxide with a thickness of 2 nanometers.

In both coating configurations, the sheet resistance measured is about 70 ohms per square.

For all the articles obtained in this way, the glass panes are trimmed, edged and washed, and the busbars are screen-printed manually by depositing an Ag paste in a glass frit (88% silver by weight) marketed by the company Ferro, according to the diagram shown in FIG. 4. The dimensions of the bars 3 are as follows:
bar width: 648 mm
bar spacing: 1443 mm

The article is then heated to 715° C. and tempered according to current techniques. Connectors are then welded to each of the strips 3 and electrically connected via electrical cables to a multimeter to measure their total resistance.

The articles thus obtained (reference and according to the invention) are then assembled in triple glazing with two other glass substrates comprising a low-emissivity stack incorporating a silver layer as described in Example 1 of publication FR2940272A1, according to the principles given previously and in accordance with FIG. 3 attached hereto. The heating coating is arranged on face 2 and the low-emissivity stacks are arranged on faces 3 and 5, respectively, of the triple glazing.

Like for the previous examples, for each of the configurations obtained, the total resistance of the coating 2 is measured for a plurality of glazings of both series of glazings (according to the invention and comparative).

In view of the dimensions of the busbars, the distance between them and the dimensions of the glazing, a resistance of around 155 ohms is expected, with an allowance of plus or minus 10 ohms.

FIGS. 7 and 8 show the coating resistances obtained for all the glazings measured (one point corresponding to one sample).

FIG. 7 shows the glazings of the first series of reference articles and FIG. 8 shows the glazings of the second series of articles according to the invention.

It can be seen that the glazings according to the invention show less and very low variability in the total strength of the stack after tempering.

Additionally, some samples in the reference series even fall outside the required specification, as can be seen in FIG. 7, whereas all the samples according to the invention comply with said specification (cf. FIG. 8).

Additional real-life tests have shown that the use of such a glazing as a transparent freezer door effectively prevents the formation of condensation on the outer surface of the glazing and ensures perfect visibility through it in cold conditions of around −24° C., even when a low voltage is applied to the heatable coating, namely of about 110 V or even less.

In particular, tests have shown that no traces of condensation appear on the outer surface of a triple glazing according to the invention, under conditions of an outside temperature from 35 to 40° C. and a humidity level of about 75 to 85%, when the temperature of the refrigerated compartment is maintained at −24° C.

1. A glass article comprising a glass substrate whereupon a heatable coating is deposited, said heatable coating comprising the following succession of layers, starting from the surface of said substrate:
a first layer of dielectric material comprising silicon nitride, having a thickness of between 1 and 20 nm,
a layer based on transparent conducting oxide (TCO), having a thickness of between 1 and 40 nm,
a second layer of dielectric material comprising silicon nitride, having a thickness of between 1 and 20 nm, and
a layer comprising a titanium oxide, a zirconium oxide or a titanium zirconium oxide, with a thickness of between 1 nm and 15 nm.

2. The glass article according to claim 1, wherein the electrically conductive layer comprises indium tin oxide.

3. The glass article according to claim 1, wherein the electrically conductive layer has a thickness from 8 nm to 15 nm.

4. The glass article according to claim 1, wherein the electrically conductive layer has a thickness from 15 nm to 30 nm.

5. The glass article according to claim 1, wherein said first dielectric layer consists essentially of silicon nitride, optionally doped with an element selected from Al, Zr, B, said first dielectric layer optionally being partially oxidized by a heat treatment.

6. The glass article according to claim 1, wherein said second dielectric layer consists essentially of silicon nitride, optionally doped with an element selected from Al, Zr, B, said second dielectric layer optionally being partially oxidized by a heat treatment.

7. The glass article according to claim 1, further comprising at least two busbars arranged above and in contact with said heatable coating.

8. The glass article according to claim 7, wherein said at least two busbars are arranged along two opposite ends of said article.

9. The glass article according to claim 1, wherein said heatable coating has a sheet resistance of between 50 ohms per square and 400 ohms per square.

10. The glass article according to claim 1, wherein the substrate is a thermally prestressed glass pane, before or after deposition of said coating.

11. A multiple glazing, comprising a glass article according to claim 1 and at least one other glass substrate separated from said article by a layer of gas or a thermoplastic sheet, said coating being in contact with the layer of gas or the thermoplastic sheet.

12. The multiple glazing according to claim 11, wherein said coating is deposited on face 2 or face 3 of said glazing.

13. The glazing according to claim 11, further comprising a low-emissivity stack.

14. The multiple glazing according to claim 11, wherein the glazing is a double glazing.

15. The multiple glazing according to claim 11, wherein the glazing is a triple glazing.

16. The triple glazing according to claim 15, wherein said coating is deposited on face 2 or face 5 of said glazing.

17. The triple glazing according to claim 15, wherein said coating is deposited on face 2 of said glazing and wherein said glazing comprises a low-emissivity coating, said low-emissivity coating being arranged on face 3 and/or on face 5.

18. The triple glazing according to claim 15, wherein said coating is deposited on face 5 of said glazing and wherein said glazing comprises a low-emissivity coating, said low-emissivity coating being arranged on face 2 and/or on face 4.

19. The multiple glazing according to claim 13, wherein said low-emissivity stack(s) comprises at least one layer of silver and layers of dielectric materials.

20. The multiple glazing according to claim 13, wherein said low-emissivity stack(s) comprises a layer of ITO and layers of dielectric materials.
